(19) United States
(12) Patent Application Publication
(10) Pub. No.: US 2009/0141342 A1
(43) Pub. Date: Jun. 4, 2009

(54) MULTI-LAYER MIRROR FOR RADIATION IN THE SOFT X-RAY AND XUV WAVELENGTH RANGE

(75) Inventors: Marcus Jozef Henricus Kessels, Susteren (NL); Jan Verhoeven, Kockengen (NL)

Correspondence Address: PAUL, HASTINGS, JANOFSKY & WALKER LLP, 875 15th Street, NW, Washington, DC, 20005, US

(73) Assignee: STICHTING VOOR FUNDAMENTEEL ONDEROZOEK DERMATERIE, GA Utrecht (NL)

(21) Appl. No.: 11/720,541

(22) PCT Filed: Dec. 15, 2005
(86) PCT No.: PCT/NL2005/000860

§ 371 Date: Feb. 5, 2009

(30) Foreign Application Priority Data
Dec. 21, 2004 (NL) 1027836

(51) Int. Cl. G21K 1/06; G02B 1/00

(52) U.S. Cl. 359/359; 378/145

(57) ABSTRACT

Multi-layer mirror for radiation with a wavelength in the wavelength range between 0.1 nm and 30 nm, comprising a stack of thin films substantially comprising scattering particles which scatter the radiation, which thin films are separated by separating layers with a thickness in the order of magnitude of the wavelength of the radiation, which separating layers substantially comprise non-scattering particles which do not scatter the radiation, wherein the separating layers are covered on at least one side in each case by an intermediate layer of a material which can be mixed with the material of the thin films and the material of the separating layers.

The invention relates to a multi-layer mirror for radiation with a wavelength in the wavelength range between 0.1 nm and 30 nm, comprising a stack of thin films substantially comprising scattering particles which scatter the radiation, which thin films are separated by separating layers with a thickness in the order of magnitude of the wavelength of the radiation, which separating layers comprise substantially non-scattering particles which do not scatter the radiation, or at least do so to lesser extent than the scattering particles. The wavelength range between 0.1 nm and 30 nm comprises the soft X-ray range (wavelength between 0.1 nm and 10 nm) and a part of the so-called XUV range (wavelength between 10 nm and 100 nm).

Multi-layer mirrors for radiation with a wavelength in the wavelength range between 0.1 nm and 30 nm are applied as optical elements in set-ups in laboratories and production facilities, for instance for lithography in the wavelength range between about 10 nm and 15 nm (the so-called extreme UV range (EUV)), for X-ray fluorescence analysis of elements having a low atomic number Z, or for the purpose of X-ray microscopy on biological preparations.

Known from the Netherlands patent no. 1018139 is a multi-layer mirror wherein the scattering particles are selected from the groups of transition elements from the fourth and the sixth period of the periodic system of elements, in particular from the transition elements cobalt (Co), nickel (Ni), tungsten (W), rhenium (Re) and iridium (Ir), wherein the non-scattering particles are substantially passivated particles of lithium (Li).

Also known are multi-layer mirrors with thin films of tungsten (W) separated by separating layers of Si.

It is an object of the invention to provide a multi-layer mirror having a substantially higher reflectivity for radiation in the XUV range than the known multi-layer mirrors.

This object is achieved with a multi-layer mirror of the type specified in the preamble, wherein according to the invention the separating layers are covered on at least one side in each case by an intermediate layer of a material which can be mixed with the material of the thin films and the material of the separating layers.

It has been found that in the production of a multi-layer mirror according to the prior art islands of the material of the thin films can form during the deposition of a thin film on a separating layer. Such islands impart a non-uniform structure to the surface of the separating layer which results in a decline in the reflectivity of this surface.

By covering the separating layer in each case with an intermediate layer of a material which can be mixed with the material of the thin films and the material of the separating layers in a multi-layer mirror according to the invention, the reflectivity of thin films is increased to a significant extent because the forming of islands of the material of thin films is prevented with the intermediate layers.

In an embodiment of a multi-layer mirror according to the invention the non-scattering particles are selected from the group comprising carbon (C) and passivated silicon (Si:H), and the material of the intermediate layer is silicon (Si).

The scattering particles in a multi-layer mirror according to the invention are for instance selected from the groups of transition elements from the fourth, fifth and sixth period of the periodic system of elements, more particularly from the transition elements cobalt (Co), nickel (Ni), molybdenum (Mo), tungsten (W), rhenium (Re) and iridium (Ir).

In another embodiment the scattering particles are particles of nickel, and the non-scattering particles are particles of carbon.

In a preferred embodiment the scattering particles are particles of tungsten, and the non-scattering particles are particles of passivated silicon.

In a multi-layer mirror according to the invention the stack comprises for instance at least 10 layers of thin film separated by separating layers.

The stack preferably comprises about 100 layers of thin film separated by separating layers, more preferably the stack comprises about 500 layers of thin film separated by separating layers.

The preference for the highest possible number of layers of thin film separated by separating layers is motivated by the fact that the reflectivity of a multi-layer mirror according to the invention increases as the number of layers of thin film increases.

The invention will be elucidated in the following on the basis of exemplary embodiments, with reference to the drawings.

In the drawings

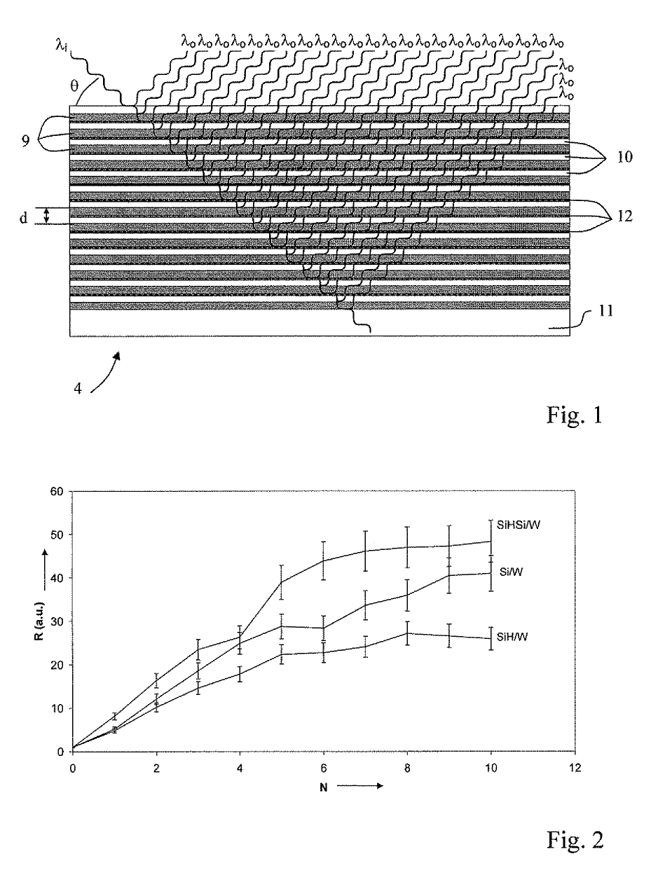

FIG. 1 shows in cross-section a schematic view of an embodiment of a multi-layer mirror according to the invention, and

FIG. 2 shows the reflectivity of two prior art multi-layer mirrors and of a multi-layer mirror according to the invention as a function of the number of layers.

FIG. 1 shows a schematic view in cross-section of a multi-layer mirror 4 which is built up from a large number (250-500) of layers of alternating thin films 9 of tungsten, intermediate layers 12 of silicon and separating layers 10 of silicon passivated with hydrogen, stacked on top of each other on a substrate 11 of a suitable material, for instance silicon wafers or glass. In order to prevent oxidation the upper tungsten thin-film layer 9 is also covered by a layer of silicon 12. Thin films 9 have the same thickness, as do separating layers 10, wherein the sum of the thicknesses of a thin film 9, an intermediate layer 12 and a separating layer 10 defines lattice distance d. In a multilayer mirror according to the invention the lattice distance d has a value between 0.5 nm and 15 nm. An incoming radiation beam is represented symbolically by a wavy arrow λi, the outgoing radiation beams reflected onto the thin films are represented symbolically by wavy arrows λo. The angle of reflection θ for a determined wavelength λ is determined by the Bragg condition as follows:

nλ=2d sin θ(1−sin 2θ_{c}/sin 2θ)^{1/2}

wherein n is a whole number (n=1, 2, 3, . . . ) and θ_{c} is the critical angle. By adjusting the multi-layer mirror 4 to a determined angle θ relative to the incident radiation beam λ, this mirror 4 thus acts as monochromator. It has been found that the bandwidth of an X-ray mirror 4 according to the invention acting as monochromator, expressed as a fraction of the wavelength, is smaller than about 1% (Δλ/λ≦0.01, and depending on the total number of layers). For the sake of clarity only a few of the total number of thin films 9, intermediate layers 12 and separating layers 10 are shown.

FIG. 2 shows the reflectivity R measured during production (expressed in arbitrary units a.u.) of a multi-layer mirror composed of 10 layers of tungsten and silicon (Si/W, middle curve), of a multi-layer mirror composed of 10 layers of tungsten and silicon passivated with hydrogen (SiH/W, lower curve), and of a multi-layer mirror according to the invention composed of 10 thin-film layers of tungsten, intermediate layers of silicon and separating layers of silicon passivated with hydrogen (SiHSi/W, upper curve) as a function of the number of layers N. The multi-layer mirrors are manufactured in accordance with a per se known method by means of electron beam evaporation of tungsten and silicon in an ultra-high vacuum system at a basic pressure of 10⁻⁹ mbar, wherein the silicon and tungsten were vapour-deposited on silicon (100) substrates. The process was monitored instantaneously by means of in situ reflectometry of carbon-K radiation. The energy-rich ions were produced by a Kaufman ion source. A total dosage of about 10¹⁶ H⁺ ions per cm² were implanted for the purpose of passivating the silicon layers. The thickness of the tungsten thin films and the silicon or passivated silicon separating layers amounted to about 2 nm, while the thickness of the silicon intermediate layer deposited on the separating layers in the multi-layer mirror according to the invention amounted to about 0.3 nm.

Because the density of passivated silicon is lower than the density of pure silicon, the optical contrast in a multi-layer mirror with passivated silicon is higher than in a multi-layer mirror with pure silicon, and the reflectivity of the former multi-layer mirror should be higher than the reflectivity of the latter mirror. The figure indicates however that a multi-layer mirror composed of layers of tungsten and passivated silicon has a lower reflectivity than a multi-layer mirror composed of tungsten and pure silicon. This worsening in the reflectivity, which amounts to about 25%, can be attributed to the forming of islands of tungsten on the layers of passivated silicon. It has been found that in a multi-layer mirror in which according to the invention the separating layer (in this example passivated silicon) is covered with an intermediate layer of a material (silicon) which can be mixed with the material of the thin films (in this example tungsten) and the separating layers, the reflectivity increases notably (upper curve). The improvement in the effective reflectivity amounts in this example to about 20% compared to the reflectivity of the multi-layer mirror with tungsten and pure silicon.

1. Multi-layer mirror for radiation with a wavelength in the wavelength range between 0.1 nm and 30 nm, comprising a stack of thin films substantially comprising scattering particles which scatter the radiation, which thin films are separated by separating layers with a thickness in the order of magnitude of the wavelength of the radiation, which separating layers substantially comprise non-scattering particles which do not scatter the radiation, or at least do so to a lesser extent than the scattering particles, the separating layers being covered on at least one side in each case by an intermediate layer of a material which can be mixed with the material of the thin films and the material of the separating layers.

2. Multi-layer mirror as claimed in claim 1, wherein the non-scattering particles are selected from the group comprising carbon (C) and passivated silicon (Si:H), and the material of the intermediate layer is silicon (Si).

3. Multi-layer mirror as claimed in claim 1, wherein the scattering particles are selected from the groups of transition elements from the fourth, fifth and sixth period of the periodic system of elements.

4. Multi-layer mirror as claimed in claim 3, wherein the scattering particles are selected from the transition elements cobalt (Co), nickel (Ni), molybdenum (Mo), tungsten (W), rhenium (Re) and iridium (Ir).

5. Multi-layer mirror as claimed in claim 4, wherein the scattering particles are particles of tungsten and the non-scattering particles are particles of passivated silicon (Si:H).

6. Multi-layer mirror as claimed in claim 4, wherein the scattering particles are particles of nickel, and the non-scattering particles are particles of carbon.

7. Multi-layer mirror as claimed in claim 1, wherein the intermediate layer has a thickness of about 0.3 nm.

8. Multi-layer mirror as claimed in claim 1, wherein the stack comprises at least 10 layers of thin film separated by separating layers.

9. Multi-layer mirror as claimed in claim 8, wherein the stack comprises at least 500 layers of thin film separated by separating layers.

10. Multi-layer mirror as claimed in claim 9, wherein the stack comprises about 500 layers of thin film separated by separating layers.

11. Multi-layer mirror as claimed in claim 1, wherein the material of the intermediate layer is silicon (Si).
